(19) United States
(12) Patent Application Publication
(10) Pub. No.: US 2025/0079747 A1
(43) Pub. Date: Mar. 6, 2025

(54) CONNECTOR ASSEMBLY

(71) Applicant: Japan Aviation Electronics Industry, Ltd., Tokyo (JP)

(72) Inventors: Taiki HANEISHI, Tokyo (JP); Takashi OMODACHI, Tokyo (JP)

(21) Appl. No.: 18/810,270

(22) Filed: Aug. 20, 2024

(30) Foreign Application Priority Data
Aug. 31, 2023 (JP) 2023-141412

(51) Int. Cl. H01R 13/502; H01R 12/71

(52) U.S. Cl. CPC H01R 13/502; H01R 12/716

(57) ABSTRACT

Provided is a technique for reducing the size of a connector assembly. A connector assembly according to the present disclosure includes a plug connector including a plurality of plug contacts and a plug housing, and a receptacle connector including a plurality of receptacle contacts, a receptacle housing, and a receptacle hold-down mounted on the outside of the plurality of receptacle contacts in the receptacle housing. Each of the plug contacts and each of the receptacle contacts come into electrical contact by mating the plug connector and the receptacle connector with each other in a mating direction. The receptacle hold-down includes an armer part covering a part of an island part, and the armer part includes a coined part.

### INCORPORATION BY REFERENCE

This application is based upon and claims the benefit of priority from Japanese patent application No. 2023-141412, filed on Aug. 31, 2023, the disclosure of which is incorporated herein in its entirety by reference.

### BACKGROUND

The present disclosure relates to a connector assembly.

Patent Literature 1 (Japanese Unexamined Patent Application Publication No. 2015-185541) discloses a receptacle metal fitting of a receptacle connector in a connector assembly. An example of this receptacle metal fitting is a receptacle hold-down 930 shown in FIG. 9.

The receptacle hold-down 930 covers an end wall 915 and an island part 912 of a receptacle connector. The receptacle hold-down 930 includes an armer part 931, a bottom part 933, and an end part 934. The receptacle hold-down 930 is one plate-shaped body in a curved shape and made of a metal material. The armer part 931, the bottom part 933, and the end part 934 link together in this recited order.

The armer part 931 covers a part of the island part 912 of the receptacle connector. The armer part 931 includes a projecting part 931A and an arcuate part 931B. A direction in which a receptacle connector and a plug connector mate with each other in a connector assembly is referred to as a mating direction (the z-axis direction in this example). The projecting part 931A projects in the mating direction along a side wall 912A of the island part 912. The arcuate part 931B overhangs in the mating direction from the projecting part 931A. The bottom part 933 covers a bottom part 915A of the end wall 915. The end part 934 covers an end part 915B of the end wall 915.

### SUMMARY

There is a need for downsizing of such a connector assembly. A receptacle hold-down affects the size of a connector assembly. In such a connector assembly, a study of the shape of a receptacle hold-down will be conducted in terms of downsizing of the connector assembly.

An object of the present disclosure is to provide a technique for reducing the size of a connector assembly.

According to a first aspect of the present disclosure, there is provided a connector assembly including a plug connector including a plurality of plug contacts and a plug housing that holds the plurality of plug contacts; and a receptacle connector including a plurality of receptacle contacts, a receptacle housing that holds the plurality of receptacle contacts, and a receptacle hold-down mounted on outside of the plurality of receptacle contacts in the receptacle housing, wherein each of the plug contacts and each of the receptacle contacts come into electrical contact by mating the plug connector and the receptacle connector with each other in a mating direction, the plurality of receptacle contacts are arranged in a pitch direction, the receptacle housing includes two side walls extending in parallel with the pitch direction, an end wall connecting ends of the two side walls, and an island part surrounded by the two side walls and the end wall, the receptacle hold-down includes an armer part covering a part of the island part, and the armer part includes a coined part.

According to the present disclosure, the size reduction of a connector assembly is achieved.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a receptacle connector and a plug connector that are electrically disconnected;

FIG. 2 is an exploded perspective view of the receptacle connector;

FIG. 3 is a plan view of the proximity of an end part of the receptacle connector;

FIG. 4 is a sectional view along line IV-IV in FIG. 3;

FIG. 5 is an exploded perspective view of a plug connector;

FIG. 6 is a sectional view of the receptacle connector (first modified example);

FIG. 7 is a sectional view of the receptacle connector (second modified example);

FIG. 8 is a sectional view of the receptacle connector (third modified example); and

FIG. 9 is a view showing an example of a receptacle metal fitting of Patent Literature 1.

### DESCRIPTION OF EMBODIMENTS

A specific embodiment of the present disclosure will be described hereinafter in detail with reference to the drawings. The present disclosure, however, is not limited to the below-descried embodiments. The following description and the drawings are appropriately shortened and simplified to clarify the explanation.

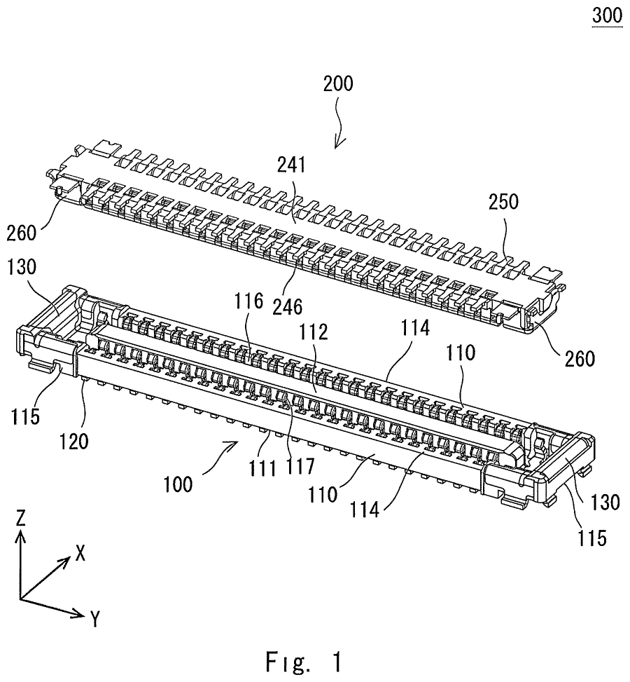

Note that the right-handed xyz coordinate system in FIG. 1 and other figures is shown for the purpose of illustrating the positional relationship of the components, and should not be interpreted as limiting the position of a receptacle connector 100, a plug connector 200 and the like when they are actually used. Generally, the x-axis direction is a width direction, the y-axis direction is a pitch direction, the z-axis direction is a mating direction in which the receptacle connector 100 and the plug connector 200 mate with each other as described later, and the xy plane is a horizontal plane, which are common among the figures.

### EMBODIMENT

An embodiment of the present disclosure will be described hereinafter with reference to FIGS. 1 to 5.

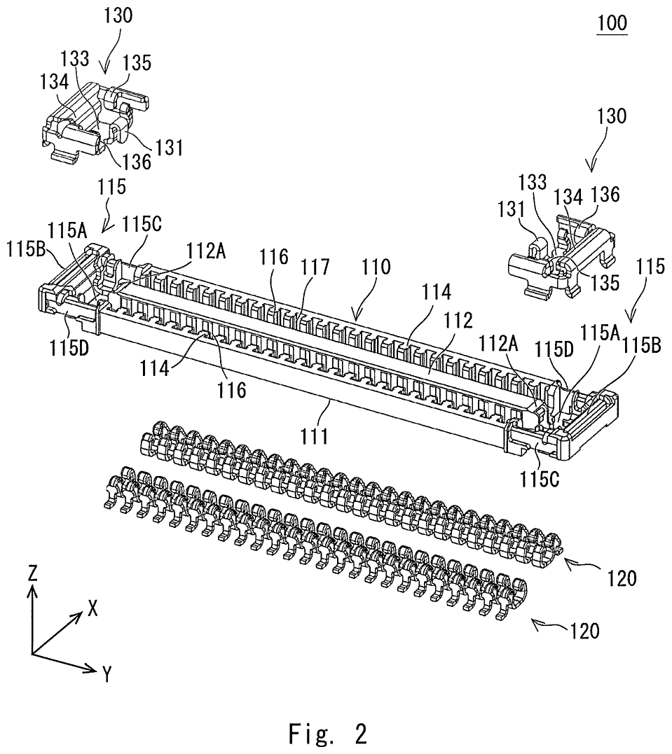

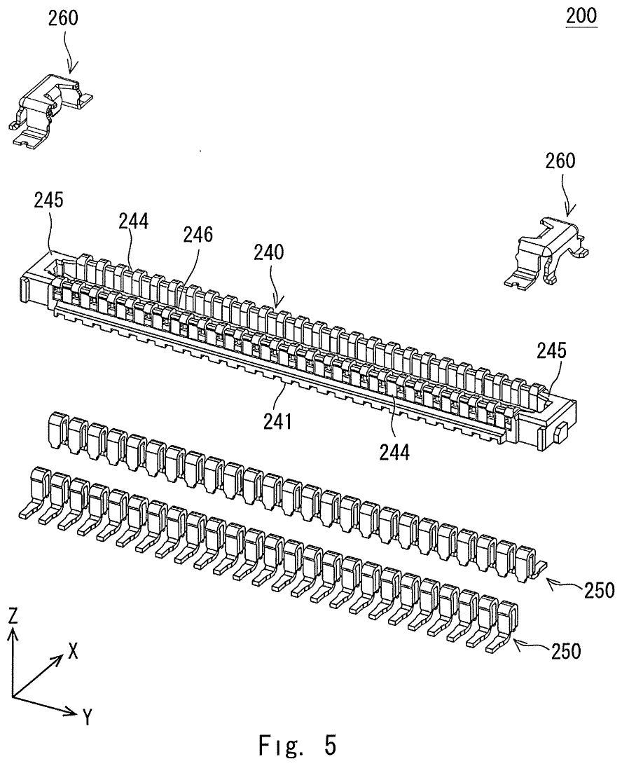

As shown in FIG. 1, a connector assembly 300 includes the receptacle connector 100 and the plug connector 200. The receptacle connector 100 shown in FIGS. 1 and 2 is disposed in such a way that a receiving space 116 faces upward (in the positive direction of the z-axis in this example). The plug connector 200 shown in FIG. 1 is disposed in such a way that a receiving space 246 faces downward (in the negative direction of the z-axis in this example). FIG. 5 is an exploded perspective view of the plug connector shown in FIG. 1. The plug connector 200 shown in FIG. 5 is disposed in such a way that the receiving space 246 faces upward, which is different from the plug connector 200 shown in FIG. 1.

The receptacle connector 100 includes a plurality of receptacle contacts 120, a receptacle housing 110, and a receptacle hold-down 130.

The receptacle housing 110 holds the plurality of receptacle contacts 120. The receptacle hold-down 130 is mounted on the outside of the plurality of receptacle contacts 120 in the receptacle housing 110.

As shown in FIGS. 1 and 5, the plug connector 200 includes a plurality of plug contacts 250, a plug housing 240, and a plug hold-down 260. The plug housing 240 holds the plurality of plug contacts 250.

The receptacle connector 100 and the plug connector 200 according to this embodiment can be mounted on different circuit boards from each other. The receptacle connector 100 and the plug connector 200 may be used as surface mounting devices, and they may be respectively mounted on printed circuit boards by soldering, for example. The receptacle connector 100 and the plug connector 200 can be used as connectors for a circuit board. The plug connector 200 and the receptacle connector 100 mate with each other in a mating direction (in the z-axis direction in this example), and thereby each plug contact 250 comes into electrical contact with each receptacle contact 120. The different circuit boards are thereby electrically connected.

A detailed structure of the connector assembly 300 is described hereinafter.

As shown in FIGS. 1 and 2, the receptacle housing 110 has a substantially rectangular parallelepiped shape, for example. The receptacle housing 110 is formed using an electrical insulating material, for example. The electrical insulating material is a resin material or the like, for example. As shown in FIG. 2, the receptacle housing 110 includes a bottom part 111, an island part 112, two side walls 114, and an end wall 115.

The bottom part 111 is preferably a plate-shaped part extending in a pitch direction (in the y-axis direction in this example). The island part 112 projects upward (in the positive direction of the z-axis in this example) from the bottom part 111 and extends in the pitch direction (in the y-axis direction in this example). The two side walls 114 project upward from the bottom part 111 and extend in the pitch direction. The two side walls 114 are disposed parallel to each other, and the island part 112 is disposed between the two side walls 114. The end wall 115 connects the ends of the two side walls 114. The end wall 115 and the island part 112 are preferably separated from each other. The receptacle housing 110 may have two end walls 115. The two end walls 115 connect the ends of the two different side walls 114, respectively. The two side walls 114 and the two end walls 115 preferably surround the island part 112. The receiving space 116 is formed between the two side walls 114, the two end walls 115, and the island part 112. The receiving space 116 is a frame-shaped body that surrounds the island part 112. The receiving space 116 has a size that is large enough to accommodate a part of the plug connector 200, such as a side wall 244 and an end wall 245, for example, when the plug connector 200 and the receptacle connector 100 mate with each other.

The end wall 115 includes a bottom part 115A, an end part 115B, and side parts 115C and 115D. The bottom part 115A is a plate-shaped part extending in the pitch direction from the bottom part 111. The side parts 115C and 115D project upward from the bottom part 111 and extend in the pitch direction. The side parts 115C and 115D are disposed parallel to and opposed to each other. The end part 115B connects the end of the side part 115C and the end of the side part 115D.

The plurality of receptacle contacts 120 are arranged in the pitch direction (in the y-axis direction in this example) in the receptacle housing 110. The pitch direction is the same as the longitudinal direction of the receptacle housing 110. The plurality of receptacle contacts 120 shown in FIG. 2 are arranged in two rows along the pitch direction. The side walls 114 preferably have a plurality of contact holding grooves 117. Each receptacle contact 120 may be disposed at each contact holding groove 117, so that the receptacle housing 110 holds the plurality of receptacle contacts 120. The contact holding grooves 117 are preferably equally spaced in the pitch direction. Each of the two side walls 114 preferably has the plurality of contact holding grooves 117. Each receptacle contact 120 is preferably axisymmetric with respect to a line extending in the longitudinal direction of the island part 112 as a center line. Each contact holding groove 117 preferably extends continuously from the side surface of the island part 112, the top surface of the bottom part 111, to the internal surface of the side wall 114. The internal surface of the side wall 114 is opposed to the side surface of the island part 112.

The receptacle hold-down 130 is mounted on the outside of the plurality of receptacle contacts 120 in the receptacle housing 110. To be specific, the receptacle hold-down 130 is mounted by press-fitting into a part of the two side walls 114, the end wall 115, and the island part 112. The receptacle hold-down 130 reinforces the receptacle housing 110. The receptacle hold-down 130 can be used as a terminal that is electrically connectable to a power supply or the like of a circuit board, which is not shown. If the receptacle hold-down 130 and the plug hold-down 260 are able to mate with each other, the plug connector 200 and the receptacle connector 100 can mate smoothly. In other words, the receptacle hold-down 130 can be used for electrical connection or mating between the plug connector 200 and the receptacle connector 100.

As shown in FIGS. 2 to 4, the receptacle hold-down 130 covers the end wall 115 and a part of the island part 112. The receptacle hold-down 130 includes an armer part 131, a bottom part 133, an end part 134, and side parts 135 and 136.

The armer part 131 is one plate-shaped body in a curved shape and made of a metal material. The end part 134, the bottom part 133, and the armer part 131 link together in the pitch direction (in the y-axis direction in this example). The side part 136, the bottom part 133, and the side part 135 link together in the width direction (in the x-axis direction in this example). The bottom part 133 covers the bottom part 115A of the end wall 115, and the end part 134 covers the end part 115B of the end wall 115. The side part 135 covers the side part 115C of the end wall 115, and the side part 136 covers the side part 115D of the end wall 115.

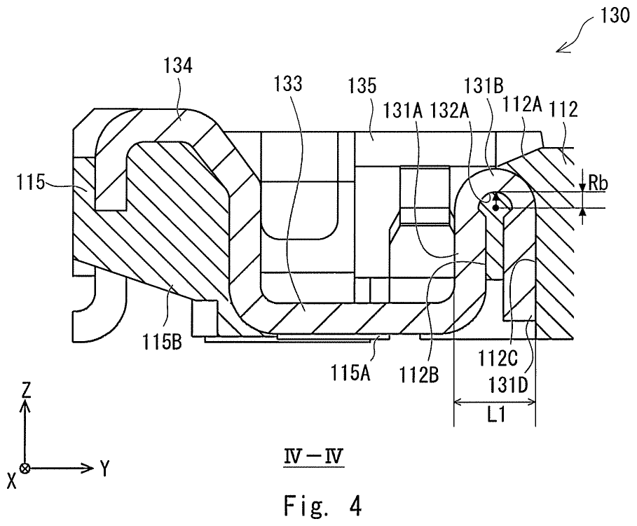

The armer part 131 covers a part of the island part 112 of the receptacle connector 100. The armer part 131 includes a projecting part 131A, an arcuate part 131B, and a distal end part 131D. The projecting part 131A projects toward the plug connector 200 (in the positive direction of the z-axis in this example) in the mating direction (the z-axis direction in this example) along an end part 112A of the island part 112. An example of the projecting part 131A shown in FIG. 4 is along a wall surface 112B of the end part 112A. The arcuate part 131B overhangs from the projecting part 131A toward the plug connector 200 in the mating direction. The arcuate part 131B is bent with a curvature radius Rb. The distal end part 131D extends from the arcuate part 131B toward the receptacle connector 100 (in the negative direction of the z-axis in this example) in the mating direction. An example of the distal end part 131D shown in FIG. 4 is inserted into a hole 112C of the end part 112A.

The armer part 131 includes a coined part 132A. The coined part 132A is formed on the arcuate part 131B. To be specific, the coined part 132A is formed on the internal surface of the arcuate part 131B, i.e., on the surface facing the receptacle connector 100 in the mating direction. The coined part 132A is formed by coining. The thickness of the coined part 132A is smaller than the thickness of the other parts of the receptacle hold-down 130. The other parts of the receptacle hold-down 130 are the projecting part 131A and the end part 134, for example, on which coining is preferably not performed.

An example of a method of manufacturing the receptacle hold-down 130 is described hereinafter. First, a plate member made of metal is punched to form a punched body. Next, coining is performed on a part of the punched body corresponding to the armer part 131 to form a part corresponding to the coined part 132A. Finally, the punched body is bent by press working to form the armer part 131, the bottom part 133, the end part 134, and the side parts 135 and 136. As described above, the thickness of the coined part 132A is smaller than the thickness of the other parts of the receptacle hold-down 130, and therefore the curvature radius Rb of the arcuate part 131B of the armer part 131 formed in this manner is small. The receptacle hold-down 130 is thereby manufactured.

As shown in FIGS. 1 and 5, the plug housing 240 has a substantially rectangular parallelepiped shape, for example. The plug housing 240 is formed using an electrical insulating material, for example. The electrical insulating material is a resin material or the like, for example. As shown in FIG. 5, the plug housing 240 includes a bottom part 241, two side walls 244, and an end wall 245.

The bottom part 241 is preferably a plate-shaped part extending in the pitch direction (in the y-axis direction in this example). The two side walls 244 project upward from the bottom part 241 and extend in the pitch direction. The two side walls 244 are disposed parallel to each other. The end wall 245 connects the ends of the two side walls 244.

The plug housing 240 may have two end walls 245. The two end walls 245 connect the ends of the two different side walls 244, respectively. The two side walls 244 and the two end walls 245 are preferably frame-shaped bodies. The receiving space 246 is formed between the two side walls 244 and the two end walls 245. The receiving space 246 has a substantially rectangular parallelepiped shape. The receiving space 246 has a size that is large enough to accommodate a part of the receptacle connector 100, such as the island part 112 shown in FIG. 1, for example, when the plug connector 200 and the receptacle connector 100 (see FIG. 1) mate with each other.

The plurality of plug contacts 250 are arranged in the pitch direction (in the y-axis direction in this example) in the plug housing 240. The pitch direction is the same as the longitudinal direction of the plug housing 240. The plurality of plug contacts 250 shown in FIG. 2 are arranged in two rows along the pitch direction. A plate member made of metal is punched to form a strip-shaped piece. Further, the strip-shaped piece may be bent, for example, to manufacture the plug contact 250. Each plug contact 250 may be integrally molded or press-fit between the two side walls 244, so that the plug housing 240 holds the plurality of plug contacts 250. The plurality of plug contacts 250 are preferably equally spaced in the pitch direction in the plug housing 240.

The plug connector 200 preferably further includes the plug hold-down 260. The plug hold-down 260 is mounted on the outside of the plurality of plug contacts 250 in the plug housing 240. To be specific, the plug hold-down 260 is mounted by integral molding or press-fit into a part of the two side walls 244 and the end wall 245. The plug hold-down 260 thereby reinforces the plug housing 240. One plate-shaped body made of metal is punched to form a punched body. Further, the punched body may be bent, for example, to form the plug hold-down 260. The plug hold-down 260 can be used as a terminal that is electrically connectable to a power supply or the like of a circuit board, which is not shown.

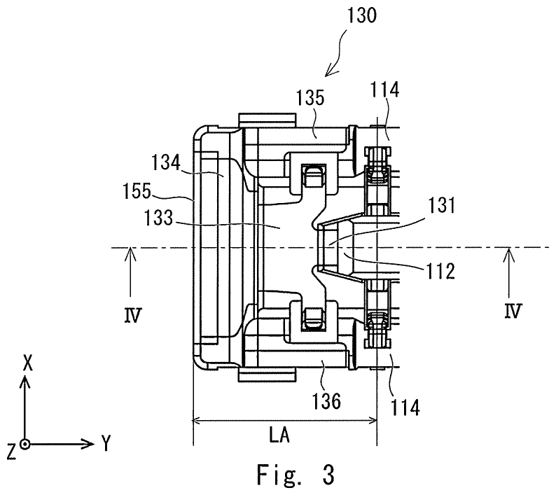

In the above-described structure of the connector assembly 300, the thickness of the coined part 132A is smaller than the thickness of the other parts of the receptacle hold-down 130. This allows forming the armer part 131 having the arcuate part 131B with a small curvature radius Rb by press work in an example of a method of manufacturing the receptacle hold-down 130 described above. Since the curvature radius Rb of the arcuate part 131B is small, a length L1 of the armer part 131 in the pitch direction, i.e., the length L1 from the projecting part 131A to the distal end part 131D, is shortened. The length LA shown in FIG. 3 is thereby shortened. The size reduction of the connector assembly 300 is thereby achieved.

### First Modified Example

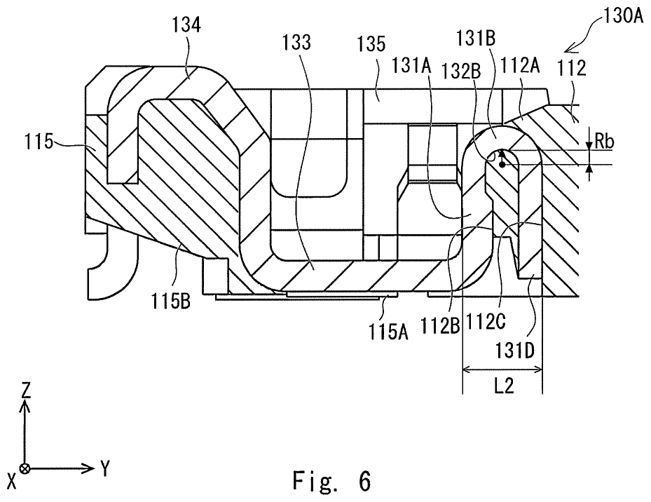

A first modified example of the receptacle hold-down 130 is described hereinafter with reference to FIG. 6. A receptacle hold-down 130A shown in FIG. 6 is the first modified example of the receptacle hold-down 130, and it has the same structure as the receptacle hold-down 130 except for a coined part.

The receptacle hold-down 130A includes a coined part 132B. The coined part 132B is formed on the arcuate part 131B. To be specific, the coined part 132B is formed on the internal surface of the arcuate part 131B, i.e., on the surface facing the receptacle connector 100 in the mating direction. The coined part 132B extends from the arcuate part 131B to the distal end part 131D. The thickness of the coined part 132B is smaller than the thickness of the other parts of the receptacle hold-down 130, just like the thickness of the coined part 132A. This allows forming the armer part 131 having the arcuate part 131B bent with a small curvature radius Rb by press work in a method of manufacturing the receptacle hold-down 130A, just like by press work in the example of the method of manufacturing the receptacle hold-down 130 described above. Since the curvature radius Rb of the arcuate part 131B is small, a length L2 of the armer part 131 in the pitch direction, i.e., the length L2 from the projecting part 131A to the distal end part 131D, is shortened. The size reduction of the connector assembly 300 is thereby achieved.

### Second Modified Example

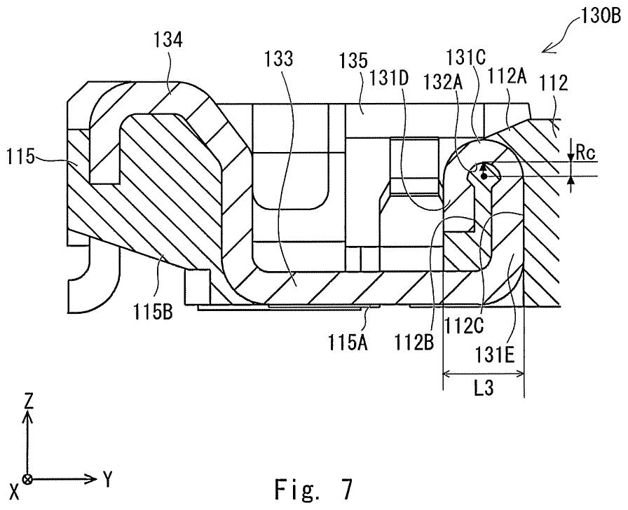

A second modified example of the receptacle hold-down 130 is described hereinafter with reference to FIG. 7. A receptacle hold-down 130B shown in FIG. 7 is the second modified example of the receptacle hold-down 130, and it has the same structure as the receptacle hold-down 130 except for an arcuate part.

The receptacle hold-down 130B includes an insertion part 131E, an arcuate part 131C, and a distal end part 131D. The arcuate part 131C is bent with a curvature radius Rc. The insertion part 131E is inserted into the hole 112C in the end part 112A of the island part 112 and extends in the mating direction. The insertion part 131E extends toward the plug connector 200 (in the positive direction of the z-axis in this example) in the mating direction. The arcuate part 131C overhangs from the insertion part 131E toward the plug connector 200 in the mating direction. The arcuate part 131C extends toward the end wall 115 (in the negative direction of the y-axis) in the pitch direction beyond the insertion part 131E. The distal end part 131D extends from the arcuate part 131C toward the receptacle connector 100 (in the negative direction of the z-axis in this example) in the mating direction. An example of the distal end part 131D shown in FIG. 7 is along the wall surface 112B of the end part 112A. The thickness of the coined part 132A is smaller than the thickness of the other parts of the receptacle hold-down 130. This allows forming the armer part 131 having the arcuate part 131C bent with a small curvature radius Rc by press work in a method of manufacturing the receptacle hold-down 130B, just like by press work in the example of the method of manufacturing the receptacle hold-down 130 described above. Since the curvature radius Rc of the arcuate part 131C is small, a length L3 of the armer part 131 in the pitch direction, i.e., the length L3 from the insertion part 131E to the distal end part 131D, is shortened. The size reduction of the connector assembly 300 is thereby achieved, just like the case of the receptacle hold-down 130.

### Third Modified Example

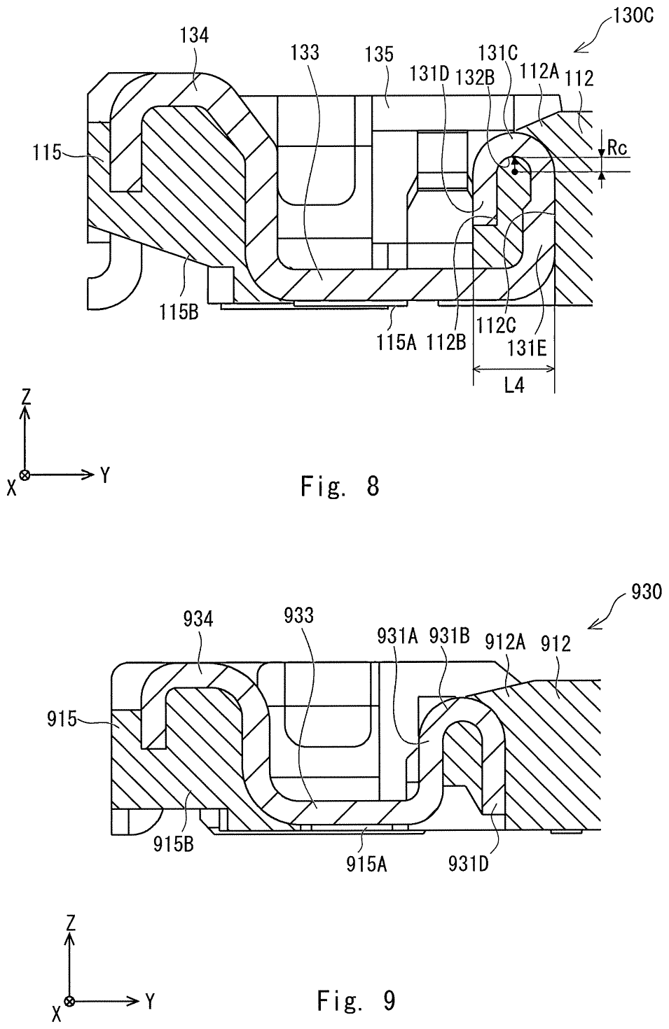

A third modified example of the receptacle hold-down 130 is described hereinafter with reference to FIG. 8. A receptacle hold-down 130C shown in FIG. 8 is the third modified example of the receptacle hold-down 130, and it has the same structure as the receptacle hold-down 130 except for a coined part and an arcuate part.

The receptacle hold-down 130C includes a coined part 132B and an arcuate part 131C. The coined part 132B is formed on the arcuate part 131C. To be specific, the coined part 132B is formed on the internal surface of the arcuate part 131C, i.e., on the surface facing the receptacle connector 100 (in the negative direction of the z-axis) in the mating direction. The coined part 132B extends from the arcuate part 131C to the distal end part 131D. The thickness of the coined part 132B is smaller than the thickness of the other parts of the receptacle hold-down 130, just like the thickness of the coined part 132A shown in FIG. 4. This allows forming the armer part 131 having the arcuate part 131C bent with a small curvature radius Rc by press work in a method of manufacturing the receptacle hold-down 130C, just like by press work in the example of the method of manufacturing the receptacle hold-down 130 described above. Since the curvature radius Rc of the arcuate part 131C is small, a length L4 of the armer part 131 in the pitch direction, i.e., the length L4 from the insertion part 131E to the distal end part 131D, is shortened. The size reduction of the connector assembly 300 is thereby achieved.

The plug connector and the receptacle connector according to the present disclosure are applicable to use as a connector mounted on various electronic equipment. For example, the plug connector and the receptacle connector according to the present disclosure are available for connection of a board such as a printed circuit board or FPC (flexible printed circuit), for example.

Note that the present disclosure is not limited to the above-described embodiments and can be modified as appropriate without departing from the spirit and scope of the present disclosure.

The first, second and third embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising:
a plug connector including a plurality of plug contacts and a plug housing that holds the plurality of plug contacts; and
a receptacle connector including a plurality of receptacle contacts, a receptacle housing that holds the plurality of receptacle contacts, and a receptacle hold-down mounted on outside of the plurality of receptacle contacts in the receptacle housing, wherein
each of the plug contacts and each of the receptacle contacts come into electrical contact by mating the plug connector and the receptacle connector with each other in a mating direction,
the plurality of receptacle contacts are arranged in a pitch direction,
the receptacle housing includes two side walls extending in parallel with the pitch direction, an end wall connecting ends of the two side walls, and an island part surrounded by the two side walls and the end wall,
the receptacle hold-down includes an armer part covering a part of the island part, and
the armer part includes a coined part.

2. The connector assembly according to claim 1, wherein the coined part extends to a distal end part of the armer part.

3. The connector assembly according to claim 1, wherein
the armer part includes a projecting part projecting in the mating direction along an end part of the island part, and an arcuate part overhanging in the mating direction from the projecting part, and
the arcuate part is disposed on the island part side in the pitch direction relative to the projecting part.

4. The connector assembly according to claim 1, wherein
the armer part includes an insertion part inserted into the end part of the island part and extending in the mating direction, and an arcuate part overhanging in the mating direction from the insertion part, and
the arcuate part is disposed on the end wall side in the pitch direction relative to the insertion part.
